(19) United States
(12) Patent Application Publication
(10) Pub. No.: US 2003/0091783 A1
(43) Pub. Date: May 15, 2003

(54) Articles of manufacture with legend insert

(76) Inventor: Sonna Calandrino, Ghent, NY (US)

Correspondence Address: John Pietrangelo, Heslin Rothenberg Farley & Mesiti P.C., 5 Columbia Circle, Albany, NY, 12203, US

(21) Appl. No.: 09/992,136

(22) Filed: Nov. 14, 2001

(51) Int. Cl. B32B 3/02; D05C 17/00

(52) U.S. Cl. 428/89; 428/88

(57) ABSTRACT

An article of manufacture and a method of fabricating an article of manufacture having a first region having an image and a second region having at least some information related to the image on the first region. The article of manufacture may be a textile or non-textile article and the information on the second region may be textual, numerical, symbolic, or graphic in nature. The article of manufacture may be a floor covering, a wall hanging, a wall covering, bedding, or apparel, among other things. A floor covering and a method for manufacturing a floor covering having a first region having an image and a second region having at least some information related to the image on the first region is also disclosed. The floor covering may be, for example, a broadloom carpet, area rug, or floor mat. The information on the second region related to the image on the first region may be textual, numerical, symbolic, or graphic in nature, for example, the information may be provided as embroidered text. The first and second region may comprise similar or different materials and may be mounted on a common backing.

### TECHNICAL FIELD

This invention relates generally to articles of manufacture and methods for providing articles of manufacture having legend inserts. Specifically, the present invention provides for textiles, for example, carpets, rugs, blankets, and towels and the like, having an image and a legend providing information about the image.

### BACKGROUND AND SUMMARY OF THE INVENTION

Carpets, rugs, tapestries, blankets, quilts, towels, and the like are often manufactured with designs or graphic art in order to make them more pleasing to the eye. These and related articles of manufacture, collectively referred to herein as “textiles,” may also include designs which relate some form of information, for example, a message or quotation, or the like. However, the information provided on such textiles is typically limited and often embedded in the fabric or fibers that make up the textile, for example, provided by varying the color of the fibers in a carpet or towel.

One aspect of the present invention comprises an article of manufacture having an image, design, or graphic, and a method of fabricating an article of manufacture having an image, design, or graphic, that is of robust construction and of aesthetically pleasing appearance while providing at least some information about, related to, or concerning the image, design or graphic. The term “image” will be used in this specification to refer to any form of image, design, graphic, photographic image, pattern, picture, display, graphic design, applique, collage, mosaic, likeness, and the like or any other form of expression capable of fixation, display or representation on an article of manufacture. Also, the term “related to” implies that the information provided is somehow related to, about, or concerning the image. Contrary to prior art articles of manufacture, which may provide information, for example, manufacturer information or material content information, on labels on the back of articles of manufacture, the present invention provides labels or “legends” on the front of articles. These legends provide at least some information related to the image that also appears on the front of the article. This information may be in textural, numerical, symbolic or graphical form, for example, embroidered text describing the history or use of what is shown in the image. Furthermore, instead of mounting a label to the article of manufacture in a fashion that is prone to damage or dislocation, as labels mounted to the back of articles in the prior art can be, according to one aspect of the present invention, the legend is securely mounted to the front of the article in a fashion that provides a durable and robust construction that can withstand the wear and tear that such articles, for example, floor coverings, can be subject to.

One aspect of the present invention is an article of manufacture comprising: a first region comprising a first material having an image; and at least one second region comprising a second material providing at least some information concerning the image on the first region. The first and second materials may be comprised of the same, similar, or different materials. The first and second materials may be natural materials, for example, wool, cotton, hemp, leather, fur, felt, flax, jute, fleece, sisal, silk, wood, rubber, paper, clay, metal, stone, glass, and the like, and combinations thereof; or a synthetic or man-made material, such as a polymer, for example, a polyester, rayon, or vinyl; plastic; an elastomer, for example, neoprene or EPDM; a refined metal; a metal alloy; a ceramic; a composite material, a laminate material, or combinations thereof, among others. Typical metals that may be used for the first or second material include aluminum, copper, brass, bronze, gold, silver, steel, and stainless steel, among others, or combinations thereof.

The information provided on the second region may be textual, numerical, symbolic, or graphic in nature. If the first and second materials are textile materials, one or both of the first and second materials may be tufted materials; woven materials, such as cloth, canvas, carpet, rugs, and lace; or non-woven materials, such as, felt, flocked materials, and needle-punched materials. The article of manufacture according to one aspect of the invention may be a floor covering, for example, a rug, a carpet, a floor mat, or tile; a wall hanging, for example, a tapestry or a curtain; a wall covering, for example, wall paper or a border; a furniture covering, for example, upholstery, a pillow case, or a slip cover; bedding, for example, a quilt, a blanket, a sheet, a pillow case, or a pillow; apparel, for example, a shirt, blouse, dress, pants, jacket, uniform, or protective apparel (such as, for hazardous material protection apparel, firefighting apparel, or a wet suit); a table cloth; a napkin; a towel; or a wash cloth, and the like. In one aspect of the invention, the image and information are provided on the same side of the article.

In one aspect of the invention, the article of manufacture may also include attached novelties, for example, buttons, beads, baubles, trinkets, charms, ribbons, grommets, rivets, or sequins, and the like. These novelties may be attached to the first region or to the second region, for example, the image on the first region may be highlighted with beads or baubles, such as, crescent moons or stars. The information on the second region may also be accented with novelties, such as highlighting text with ribbon or sequins.

In another aspect of the invention, the article of manufacture may include one or more cavities, for example, a pocket. The cavity or pocket may be located on the first region, the second region, or on both regions, and may be fixed or removable. These cavities may be closeable or sealable, for example, by means of one or more zippers, buttons and button-holes, hooks, loops and beads, laces, straps, snaps, velcro, rivets, magnets, or hinges, and the like. The one or more cavities or pockets may be detachable from the first or second region, for example, by means of velcro, zippers, or buttons. The one or more cavities or pockets may also contain or conceal information, for example, information, related to the article of manufacture, the image, or legend. For instance, a pocket may contain a removable textile bearing information, textual or otherwise, related to the article, the image, or the legend. The one or more cavities may also contain an article, for example, a book, a soft sculpture, a stuffed animal, or a toy. The cavity may simply be a removable or moveable cover for a textile mounted to the first or second region containing information related to the article, the image, or legend.

The information provided on the second region may be provided by any means of writing or printing. The means of writing or printing may include embossing (for example, embossing leather), carving, etching, burning, or branding. If the second material is a textile, the information may be provided as needlework, for example, embroidery, cross-stitch, or crocheting. The at least one second region may be a plurality of second regions, for example, 2 or more or 3 or more regions. The plurality of second regions may be evenly or unevenly spaced about the first region.

Another aspect of the present invention comprises a method of providing an article of manufacture, the method comprising: providing a first region of the article having an image; and providing a second region of the article containing at least some information related to the image. Again, the information may be textual, numerical, symbolic, or graphical. The method of the invention may further comprise providing a substrate for mounting the first region, or providing a substrate for mounting the first and second regions. The article of manufacture may be any one of the articles listed above. In one aspect of the invention, providing a first region of the article is practiced by tufting fibers to the substrate. In another aspect of the invention, providing a second region comprises removing at least some of the material of the first region to produce a void in the first region and mounting a second material in the void. The second material may include at least some information related to the image or the information may be provided after mounting the second material. In another aspect of the invention, the image and information are provided on the same side of the article.

Another aspect of the invention is an article of manufacture comprising: a first region comprising a first material having an image, the first region having a perimeter and at least one void within the perimeter; and at least one second region positioned within the void comprising a second material containing at least some information related to the image. Again, the at least some information may be textual, numerical, symbolic, or graphical in nature. Also, the at least one second region may be a plurality of second regions. In one aspect of the invention, the first and second materials are textile materials. In one aspect of this invention, the first textile material is a woven or non-woven material, for example, a tufted material.

Another aspect of this invention is a floor covering comprising: a first region comprising a first material having an image; and at least one second region comprising a second material having at least some information related to the image on the first region. The first and second materials may be comprised of the same, similar, or different materials. The first and second materials may be natural materials, for example, wool, cotton, hemp, leather, ceramic, and the like, or a synthetic material, such as a polymer or plastic. The information provided on the second region may be textual, numerical, symbolic, or graphical in nature. In one aspect of the invention, the first region includes a void and the second region is positioned in the void. The first region may also include a perimeter and the void is located within the perimeter. The floor covering may also include a backing, for example, a polypropylene backing, and the first region may be mounted to this backing. The second region may also be mounted to this backing, for example, by means of an adhesive or stitching. The first region and the second region may be mounted on a common backing. In another aspect of the invention, the floor covering may include a substrate, and the first or second region, or both regions, may be mounted to the substrate. The floor covering according to the present invention may be a carpet, area carpet, broadloom carpet, rug, area rug, mat, or ceramic tile. In one aspect of the invention, the image and information are provided on the same side of the floor covering.

Another aspect of the invention is a method of fabricating a floor covering, comprising: providing a first region comprising a first material having an image; and providing at least one second region comprising a second material having at least some information related to the image on the first region. The first material may be provided in the form of fibers. Also, providing at least one second region may be practiced by creating a void in the first region and mounting the second region in the void. The first region may be provided by tufting fibers to a substrate. According to one aspect, the second material may be a textile or a non-textile material.

Another aspect of the invention is a method of fabricating a floor covering, comprising: providing a substrate; attaching a first material to the substrate to produce a region of first material; providing an image on the region of first material; providing at least one void in the region having little or no material; providing a second material having at least some information related to the image; and mounting the at least one second material in the at least one void. The first material may be in the form of fibers. The second material may be a textile or a non-textile material. In one aspect, providing a void in the region is practiced by removing material from the substrate, for example, by cutting or shaving.

A further aspect of this invention is a method of fabricating a floor covering, comprising: providing a substrate; attaching fibers to the substrate to produce a region having fibers; providing an image on the region; providing at least one void in the region having little or no fibers; providing at least one textile having at least some information related to the image; and mounting the at least one textile in the at least one void. In one aspect of this invention, the fibers are attached to the substrate by tufting. In another aspect of the invention, the image is provided to the first region during the practice of attaching fibers to the substrate. There may be one or more images on the region. The void in the first region may be provided by removing fibers from the substrate, for example, by means of cutting or shaving. The void may also be provided by omitting fibers while attaching fibers to the substrate. One means of attaching fibers to the substrate is by using a mechanical device, for example, a loom or tufting machine. In one aspect of the invention, the mechanical device is an automated tufting machine, for example, a programmable automated tufting machine. The mechanical device may be programmed to both provide the image and omit fibers to provide the void. The at least one void may comprise a plurality of evenly or unevenly spaced voids. A plurality of textiles may be mounted in the plurality of voids. One or more of the plurality of textiles may comprise some information related to the one or more images. The textiles may be mounted by conventional means, for example, by means of adhesives or stitching. In one aspect of the invention, the image and information are provided on the same side of the floor covering.

An even further aspect of the present invention is a tufted carpet comprising: a substrate onto which fibers are tufted; a first region of tufted fibers mounted to the substrate, the first region having an image; a second region having little or no tufted fibers; and a material mounted in the second region providing at least some information related to the image. The material mounted in the second region may be a textile or non-textile material, for example leather, though any other non-textile mentioned above may be used. The mounting of the material in the second region may be a fixed mounting or a removable mounting. The textile material may be a woven or non-woven material. The information related to the image provided on the textile material may be textual, numerical, symbolic, or graphical information. The information on the textile material may be provided by needlework, for example, embroidery, crochet, or cross-stitch. In one aspect of the invention, the image and information are provided on the same side of the tufted carpet.

A still further aspect of the present invention is an article of manufacture comprising: a first region comprising a first material having an image; and at least one second region comprising a second material. Again, the first and second materials may be comprised of the same, similar, or different materials. Again, the at least one second region may be a plurality of second regions. In one aspect of this invention, at least one of the plurality of second regions may contain at least some information related to the image on the first region. The first and second materials may be natural or synthetic materials, for example, those materials mentioned above. In one aspect of this invention, the second region contains little or no information concerning the image, that is, in one aspect of the invention the second region does not include a “legend”. The second region may be fixed or removably mounted to the first region. The second region may be mounted, either fixedly or removably, by means of any one or more of the mounting means disclosed above.

These and other embodiments and aspects of the present invention will become more apparent upon review of the attached drawings, description below, and attached claims.

### BRIEF DESCRIPTION OF THE DRAWINGS

The subject matter which is regarded as the invention is particularly pointed out and distinctly claimed in the concluding portion of the specification. The invention, however, both as to organization and method of fabrication, together with further objects and advantages thereof, may best be understood by reference to the following detailed descriptions of the preferred embodiments and the accompanying drawings in which:

FIG. 1 is a plan view of an article of manufacture having a legend according to one aspect of the present invention.

FIG. 2 is a detailed view of the legend that appears in the article of manufacture shown in FIG. 1.

FIG. 3 is a cross-sectional view of the mounting of the legend shown in FIG. 2 as viewed along the section lines 3-3.

FIGS. 4-9 illustrate various typical alternative locations and orientations of one or more legends in an article of manufacture according to the present invention.

FIG. 10 is a plan view similar to FIG. 1 illustrating one aspect of the present invention.

FIG. 11 is a detailed view of the legend that appears in the aspect shown in FIG. 10.

FIG. 12 is a cross-sectional view of the mounting of the legend shown in FIG. 11 as viewed along the section lines 12-12.

FIG. 13 is a plan view of a pocket according to one aspect of the invention.

FIG. 14 is a cross-sectional view of the pocket shown in FIG. 13 as viewed from a direction indicated by arrows 14-14.

FIG. 15 is a partial plan view of the pocket shown in FIG. 13 in the opened positioned.

### DETAILED DESCRIPTION OF THE PREFERRED EMBODIMENTS

FIG. 1 illustrates a plan view of an article of manufacture 10 incorporating one aspect of the present invention. Article 10 may be any form of article of manufacture. Article 10 may be a floor covering, for example, a rug, a carpet, a floor mat, or tile; a wall hanging, for example, a tapestry or a curtain; a wall covering, for example, a wall paper or a border; a furniture covering, for example, upholstery or a slip cover; bedding, for example, a quilt, a blanket, a sheet, a pillow, or a pillow case; apparel, for example, a shirt, a blouse, a dress, pants, a jacket, a uniform, or protective apparel (such as, for hazardous material protection apparel, firefighting apparel, or a wet suit); a table cloth; a napkin; a towel; or a wash cloth; and the like, among others articles. According to one aspect the present invention, article 10 includes a first region 12 bearing an image 14 and second region 16 containing at least some information about the image 14. Region 12 of article 10 typically comprises one form of material, for example, a tufted, woven, or non-woven material (though many other types of material may be used) and region 16 typically comprises a second similar or different material. The materials of construction of regions 12 and 16 may take any form, for example, one of the many materials mentioned above, but in one aspect of the invention, regions 12 and 16 are constructed of textile materials, for example, woven or non-woven cloth. Image 14 may be any form of image including, but not limited to, geometrical designs, graphic designs, photographs, images of articles, images of fashions, plants, animals, people, events, landscapes, landmarks, scenes of nature, concepts, ideas, scientific concepts and principles, literary works, works of art, historic scenes, signs of the zodiac, brands, trademarks, trade dress, insignias, tartans, genealogical symbols, images of heraldry, or coats of arms, among others. Image 14 may be provided to region 12 by any conventional means, including but not limited to, printing, painting (by hand or machine), silk-screening, stenciling, embossing, appliqueing, crocheting, tufting, weaving, flocking, needle-punching, or embroidering, among others, or any other form of expression capable of fixation an image on region 12. In one aspect of the invention, image 12 is provided by photo-imaging, for example, computer-assisted photo-imaging.

According to the present invention, article 10 may take any geometric shape, for example, square, rectangular, circular, or triangular, among others, or a non-geometric shape, for example, an arbitrary shape. The present invention is also not limited to 2-dimensional or planar embodiments, that is, the present invention may also be 3-dimensional in shape, for example, article 10 may take the form of a box, cube, ball, or pyramid, and the like.

According to the present invention, at least some information concerning image 14 is provided in region 16. Throughout this specification region 16 is typically referred to as a “legend”. The information presented in legend 16 may be textural in nature, for example, legible English- or non-English-language text; numerical, for example, numerals or equations; symbolic, for example, signs of the Zodiac or Celtic runes, or graphical, for example, graphical images relaying some information about the image 14. The information in legend 16 may be provided by any conventional means, including but not limited to, hand-writing, printing, painting (by hand or machine), silk-screening, stenciling, embossing, appliqueing, crocheting, tufting, weaving, flocking, needle-punching, or embroidering, among others, or combinations thereof, or any other form of expression capable of fixation on legend 16. In one aspect of the invention, the information in legend 16 is provided by photo-imaging, for example, computer-assisted photo-imaging. In one aspect of the invention, legend 16 contains little or no information related to image 14.

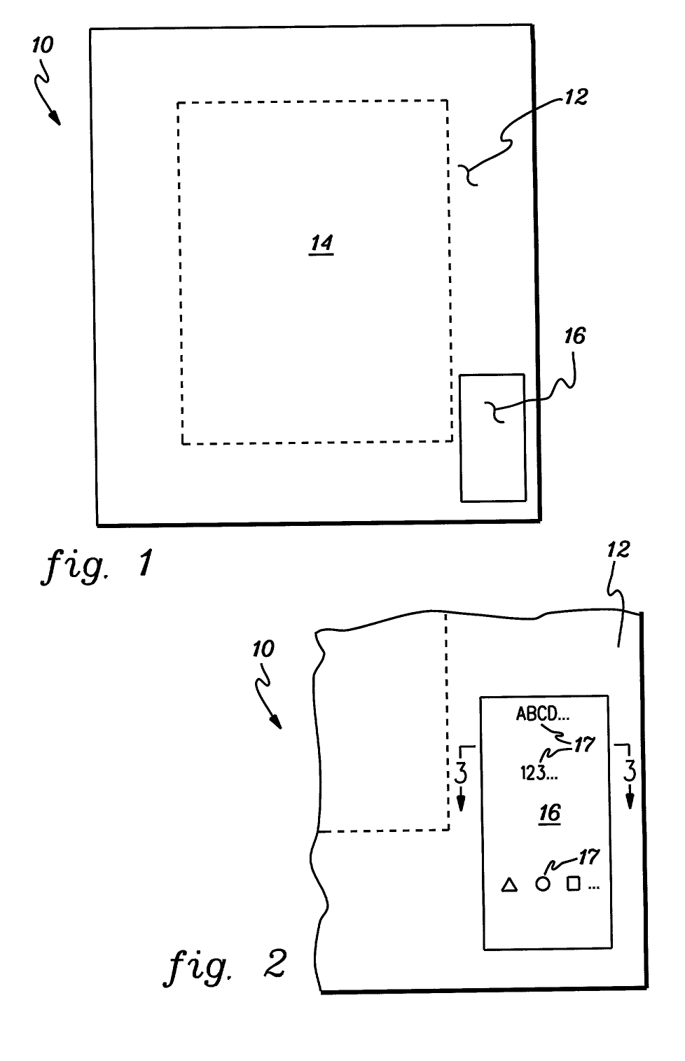

As described above with respect to article 10, according to one aspect of the invention, legend 16 may take any shape, for instance, a geometric shape, for example, square, rectangular, circular, or triangular, among others, or a non-geometric shape, for example, an arbitrary shape. Legend 16 may be positioned in any orientation, for instance, any orientation relative to article 10. For example, the axes or edges of legend 16 may be parallel or perpendicular to the axes or edges of article 10 or the axes or edges of legend 16 may be oblique to the axes or edges of article 10. The position and orientation of legend 16 may also be randomly located and randomly oriented with respect to article 10 and image 14. A detailed view of a typical legend 16 shown in FIG. 1 is shown in FIG. 2. FIG. 2 illustrates typical textural, numerical, and graphical information 17 that can be provided by legend 16.

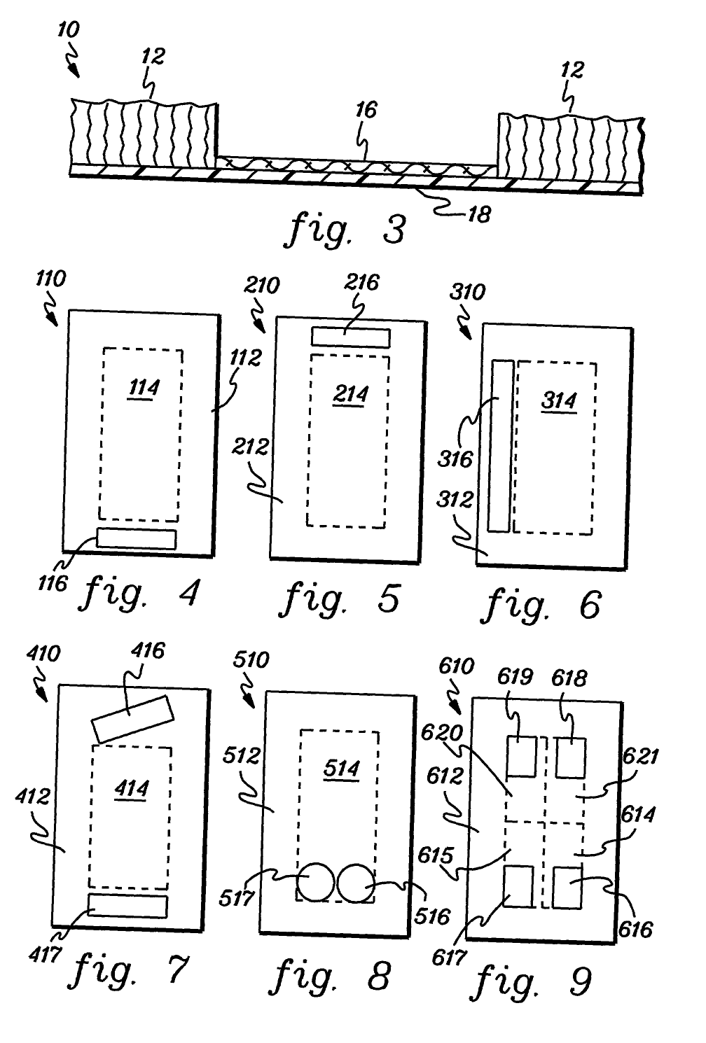

A cross-sectional view of legend 16 as viewed along lines 3-3 of FIG. 2 is illustrated in FIG. 3. FIG. 3 illustrates how region 12 of article 10 and legend 16 may be mounted on a common backing or substrate 18. This optional substrate 18 may be any form of appropriate backing material, for example, a natural-material backing, such as hemp, jute, or rubber, or a synthetic material, such as polypropylene, nylon, polyester, or an elastomer, or combinations thereof. Region 12 and legend 16 may be attached to substrate 18 by any conventional means, for example, by means of adhesives; by tufting; by sewing; by melting, such as by welding (for example, sonic welding) or by means of an “iron-on”; or by mechanical fasteners, such as rivets, one or more zippers, clasps, bolts, screws, or snaps, among other typical mechanical fasteners. When a substrate is not provided, for example, when region 12 is a woven textile, legend 16 may be attached directly to region 12 by adhesives, stitching, sewing, laces; stapling, velcro, or by one or more of the mechanical fasteners mentioned above. In one aspect of the invention, legend 16 may be removably mounted to substrate 18 or to region 12. Though in FIG. 3 the surface of legend 16 is shown beneath the surface of region 12, the surface of legend 16 may be above, below, or at essentially the same elevation as the surface of region 12.

FIGS. 4-9 illustrate various typical alternative locations and orientations of one or more legends in an article of manufacture according to the present invention. The materials, regions, and legends illustrated in FIGS. 4-9 are similar in design, mounting, and construction to article 10, region 12, image 14, and legend 16 shown in FIGS. 1-3. FIG. 4 illustrates an article 110 having a region 112 bearing an image 114 and a legend 116 providing information concerning image 114. In this aspect of the invention, legend 116 is located in the lower half of article 110, for example, below image 114.

FIG. 5 illustrates an article 210 having a region 212 bearing an image 214 and a legend 216 providing information concerning image 214. In this aspect of the invention, legend 216 is located in the upper half of article 210, for example, above image 214.

FIG. 6 illustrates an article 310 having a region 312 bearing an image 314 and a legend 316 providing information concerning image 314. In this aspect of the invention, legend 316 is located in the left-hand side of article 310, for example, to the left of image 314. It is understood that legend 316 may also be located in the right-hand side of article 310, for example, to the right of image 314.

FIG. 7 illustrates an article 410 having a region 412 bearing an image 414 and legends 416 and 417 providing information concerning image 414. It is understood that image 414 may comprise two or more images and legend 416 may provide information concerning one image and legend 417 may provide information concerning another image. Furthermore, it is understood that two or more images, for example, three or more images may appear on article 410 and have 2 or 3 or more legends. In the aspect to the invention shown in FIG. 7, legend 416 is located toward the top of or above image 414 and legend 417 is located toward the bottom of or below image 414. It is understood that legends 416 and 417 may also straddle image 414, that is, legend 416 may be positioned on the left side or to the left of image 414 and legend 417 may be positioned on the ride side of or to the right of image 414. FIG. 7 also illustrates one example of how legend 416 can be oriented at a oblique angle, for example, an oblique angle relative to the edges of article 410.

FIG. 8 illustrates an article 510 having a region 512 bearing an image 514 and legends 516 and 517 providing information concerning image 514. FIG. 8 also illustrates that according to the present invention legends 516 and 517 can be circular in shape, among other shapes. It will be apparent to those of skill in the art that legends may assume any geometric or non-geometric shape. Again, it is understood that image 514 may comprise two or more images and legend 516 may provide information concerning one image and legend 517 may provide information concerning another image. Furthermore, it is understood that two or more images, for example, three or more images may appear on article of manufacture 510 and have 2, or 3, or more legends. In the aspect of the invention shown in FIG. 8, legends 516 and 517 are located toward the bottom of or below image 514. It is understood that legends 516 and 517 may also be positioned approximately in the middle of article 510, or toward the top of article 510.

FIG. 9 illustrates an article 610 having a region 612 bearing images 614, 615, 620, and 621 and legends 616, 617, 618, and 619 providing information concerning one or more images 614, 615, 620, and 621. For example, legend 616 may provide information concerning image 614; legend 617 may provide information concerning image 615; legend 618 may provide information concerning image 621; and legend 619 may provide information concerning image 620. In the aspect of the invention shown in FIG. 9, legends 616-619 are located approximately in the corners of article 610 and adjacent to their respective images, however, legends 616-619 may be located anywhere on article 610 with little or no physical proximity to the respective image to which each legend is related. Though four legends and four images appear in FIG. 9, it will be understood by those of skill in the art that any number of images and legends may be used, for example, 2 or more images and legends, or 8 or more images and legends. Furthermore, the number of legends need not equal the number of images; there may be more images than legends or less images than legends. In addition, though the images and legends 616-619 are shown approximately equally spaced about article 610 in FIG. 9, it will be apparent to those of skill in the art that the images and legends need not be equally spaced, but may be arbitrarily spaced and grouped about article 610.

Further still, one or more of images 614, 615, 620 and 621 in FIG. 9 may lie within another image, for example, image 614 may lie partially or totally within image 615, or images 614, 615, 620 and 621 may be a series of circular or non-circular concentric images positioned about a common point, line, or plane. Again, legends 616-619 may assume any geometric or non-geometric shape.

One of skill in the art will recognize that the aspects of the invention shown in FIGS. 4-9 illustrate various typical aspects of the invention and many other variations of size, shape, location, and orientation are within the scope of this invention.

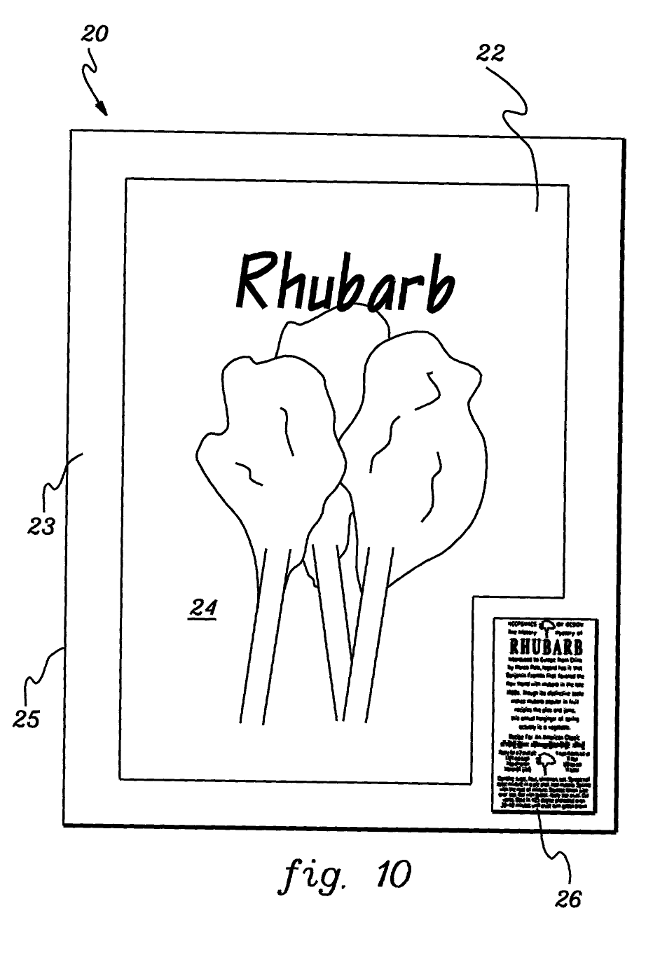

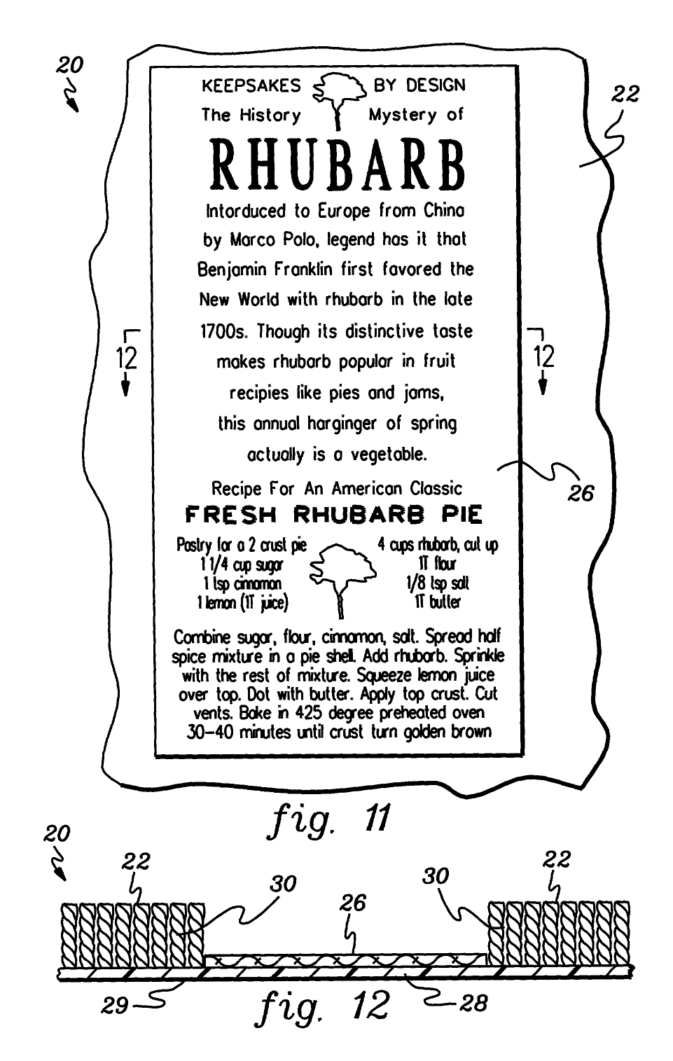

FIG. 10 illustrates one aspect of the present invention in which the article of manufacture is a carpet 20, for example, a tufted area rug, having a tufted region 22, having an border 23 and bearing an image 24, a perimeter 25, and a legend 26. In this aspect of the invention image 24 is that of a stylized rhubarb plant and legend 26 provides information related to rhubarb. A detailed view of legend 26 appears in FIG. 11 where the information related to the image 24 is provided. In this example, the information provided in legend 26 is a brief anecdotal historical item concerning rhubarb and a recipe including rhubarb as an ingredient.

Image 24 may be provide by one or more of the image fixing processes by which image 14 is provided. In one aspect of the invention, where carpet 20 is a tufted carpet, image 24 may be provided by tufting undyed multidye level yarns which are then colored after tufting in a separate dyeing operation.

FIG. 12 illustrates a cross-section of legend 26 as mounted in region 22 as viewed along lines 12-12 in FIG. 11. In FIG. 12, region 22 and legend 26 are mounted on a common substrate 28. In this aspect of the invention, substrate 28 is a polypropylene web and region 22 comprises fibers 30 tufted to substrate 28 by conventional tufting means. Fibers 30 may be fibers of any conventional material, including natural fibers, such as cotton, wood, paper (or other cellulose products), wool, silk, or linen, among others, and combinations thereof; or synthetic fibers, such as nylon, olefin, or polyester, among others, and combinations thereof. Fibers 30 may also be metallic, for example, copper, bronze, or gold, among other metals, and combinations thereof. One metallic fiber that may be used for fibers 30 is a flexible metallic fiber marketed under the name Lurex® by The Lurex Company of London, England. Fibers 30 may be comprised of a single material, or fibers 30 may be comprises of a combination of two or more of the materials mentioned above. The fibers may be cut pile, level loop, high-low loop, or cut-loop fibers, among others.

Legend 26 may also be comprised of any appropriate textile, for example, a woven textile, such as linen, lace, cloth, or canvas; a non-woven textile, such as felt, flocked material, or a needle-punched material. These textiles may be made from a natural or a synthetic fiber as mentioned above with respect to fibers 30. Legend 26 may also be comprised of a non-textile material, for example, a rubber, a plastic, or leather, among others. Legend 26 of carpet 20 may be attached to substrate 28 by means of adhesives, stitched, sewn, laced, velcro, magnets, or one or more of the mechanical fasteners mentioned above. Sewing of legend 26 to substrate 28 provides a more durable and aesthetically pleasing appearance to carpet 20. In one aspect of the invention, no substrate is present beneath legend 26. In this aspect, legend 26 may be mounted to the edge of region 22 or to the substrate beneath region 22. In one aspect of the invention, legend 26 may be removably mounted to substrate 28 or to region 22, for example, by means of velcro, snaps, lacing, or magnets. Legend 26 may also be a non-textile material, for example, leather, plastic, rubber, metal, or stone or the like, and be mounted, or removably mounted, by one or more of the means described above.

Again, the information provided on legend 26 may be textural, numerical, symbolic, or graphical. The information may be located on or inscribed into legend 26 by conventional means, including hand-written, printed, painted, silk-screened, stenciled, embossed, appliqued, crocheted, or embroidered, among others, or any other form of expression capable of fixation on legend 26. The information in legend 26 may be provided by hand or by an automated device. The information may be provided to legend 26 prior to mounting onto substrate 28 or after legend 26 is mounted onto substrate 28. In one aspect of the invention, the information on legend 26 is provided by needlework. For example, the information provided to legend 26 is provided by means of embroidery, cross-stitch, or crocheting. The needlework may be performed by hand or by means of an automated device, for example, an programable embroidery machine.

In one aspect of the invention, fibers 30 are tufted to a substrate 28 by means of an automated tufting machine, for example, by means of a Tapistron™ computerized- yarn-placement(CYP) tufting machine manufactured by CYP Technologies of Chickamauga, Ga., though other types of tufting machines or looms may be used.

In one aspect of the invention, the region 22 is fabricated by tufting fibers 30 to substrate 28 to provide a carpet 20 with a continuous region 22 of tufted fibers. In order to introduce legend 26, fibers can be removed from region 22 to produce a void into which legend 26 can be inserted. The void in region 22 can be produced by cutting or shaving, or removing fibers by any other means. In one aspect of the invention, after region 22 is fabricated by tufting fibers onto substrate 28, fibers 30 are removed with little or no damage to substrate 28 to provide a void in region 28. A textile comprising legend 26 can then be mounted to substrate 28, for example, by gluing or stitching. The void in region 22 may also be provided by varying the height of the tufted fibers, for example, the void may be provided by tufting fibers having a shorter pile height than the fibers of region 22. The shorter pile height may be provided by tufting shorter fibers or by reducing the height of a longer tufted fiber by, for example, cutting. The production of shorter tufted fibers to provide the void in region 22 can be practiced more readily by using an automated tufting machine, such as the Tapistron CYP tufting machine mentioned above. A textile comprising legend 26 can then be mounted to the surface of the shorter fibers, for example, by gluing or stitching

In another aspect of the invention, carpet 20 is fabricated on an automated device, for example, on an automated tufting machine, with a void in region 22 where the legend 26 can be inserted. For example, an automated programmable tufting machine can be programed to leave one or more untufted regions in the tufted region 22 wherein substrate 28 is untufted and exposed. The Tapistron™ CYP tufting machine discussed above is one type of device that can be programmed to produce a tufted carpet having a void into which a legend 26 can be inserted. After the tufted region 22 is produced with a void, legend 26 can be attached to the untufted substrate 28 by conventional means as discussed above.

After the fibers are tufted into the substrate 28 a backing 29 may be applied to the underside of the tufted region 22 to conceal the tufted fibers and protect the fibers and underside of substrate 28 from damage, wear, or soiling. Backing 29 may comprise any conventional backing material, for example, jute, cotton, polypropylene, nylon, or equivalents or combinations thereof.

In addition to tufted carpet, the aspect of the invention shown in FIGS. 10-12 can also be effected by other methods of fabricating carpet or rug. In one aspect the invention, carpet 20 may be fabricated by weaving, for example, region 22 of carpet 20 may be produced by weaving or interlacing strands (for example strands of yarn or 10 thread) to produce woven region 22. Weaving may be practiced by hand or machine, for example, a loom which interlaces warp and filling threads. The woven strands may be comprised of one or more of the materials described above for the fibers 30. Image 24 may be produced by interlacing strands of varying color to produce an image during the weaving process. Image 24 may also be provided after the weaving process by fixing an image to region 22 by one or more of the image producing processes described above. In the woven aspect of the invention, one or more voids for one or more legends 26 may be provided by selectively omitting strands in the weaving process or by removing one or more sections of woven material from region 22 during or after the completion of the weaving process, for example, by cutting or shearing. In the woven aspect of the invention, legend 26 may be made of any one or more of the materials and mounted by any one or more of the means described above with respect to the tufted embodiment of the invention.

The aspect of the invention shown in FIGS. 10-12 may also be effected by non-woven or non-tufted methods of fabricating carpet. For example, region 22 on carpet 20 may be needle-punched or flocked. For example, in needle-punched methods, fibers or other materials may be attached to a substrate or backing by mechanically engaging, for example, by punching, the fiber or other material into substrate 28. In flocked methods, fibers or other materials may be electrostatically attached and arranged to substrate 28 and then fixed in position, for example, by means of an adhesive. Again, image 24 may be created during the needle-punch or flocking process or image 24 may be fixed to region 22 after the needle-punch or flocking process by one or more of the image fixing processes discussed above. The materials used in these processes may be one or more of the materials described above for the fibers 30. In the needle-punch or flocking aspect of the invention, the one or more voids for the one or more legends 26 may be provided by selectively omitting fibers or materials during the punching or flocking process or by removing one or more sections of punched or flocked material from region 22 during or after the completion of the punching or flocking process, for example, by cutting or shearing. In this aspect of the invention, legend 26 may be made of any one or more of the materials and mounted by any one or more of the means described above with respect to the tufted embodiment of the invention.

The aspect of the invention shown in FIGS. 10-12 may also be effected by what are referred to in the art as “fabricated methods”. For example, one or more voids may be produced in region 22 of carpet 20 produced by tufting, weaving, punching or flocking, among others, by cutting or shearing. One or more legends 26 can then be mounted in the one or more voids by any one of the methods described above with respect to the mounting of legend 26. The present invention may also be effected by fabricating image 24, for example, image 24 may be produced by cutting or otherwise removing material from region 22 and then replacing at least some of the removed material with one or more materials bearing an image or producing an image when assembled on region 22.

It will be understood by those of skill in the art that the aspects of the invention shown in and described with respect to FIGS. 10-12, for example, the tufted carpet, may be fabricated to produce one or more of the aspects of the present invention shown in FIGS. 4-9, among others.

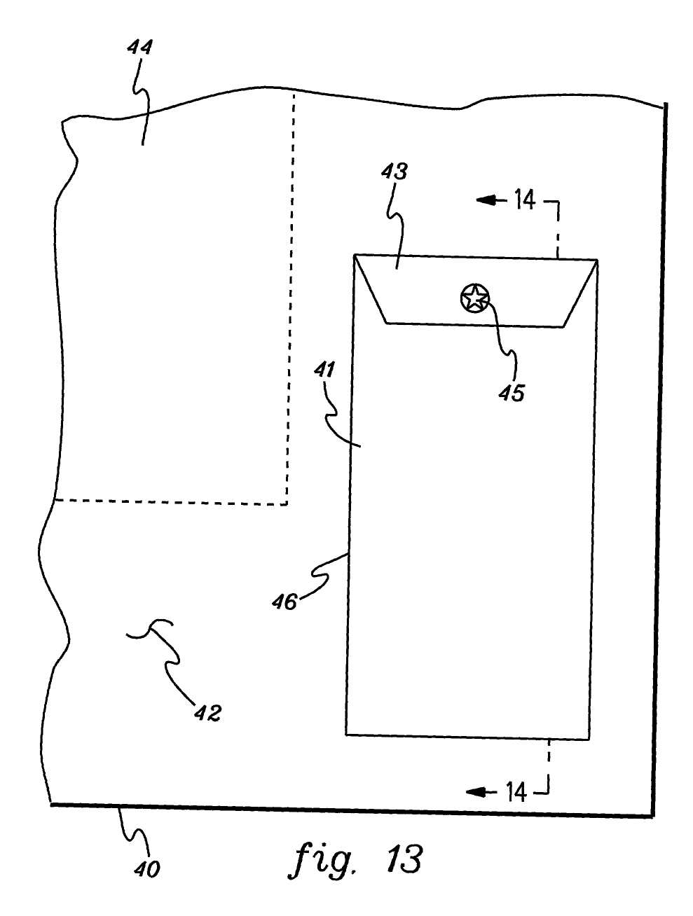

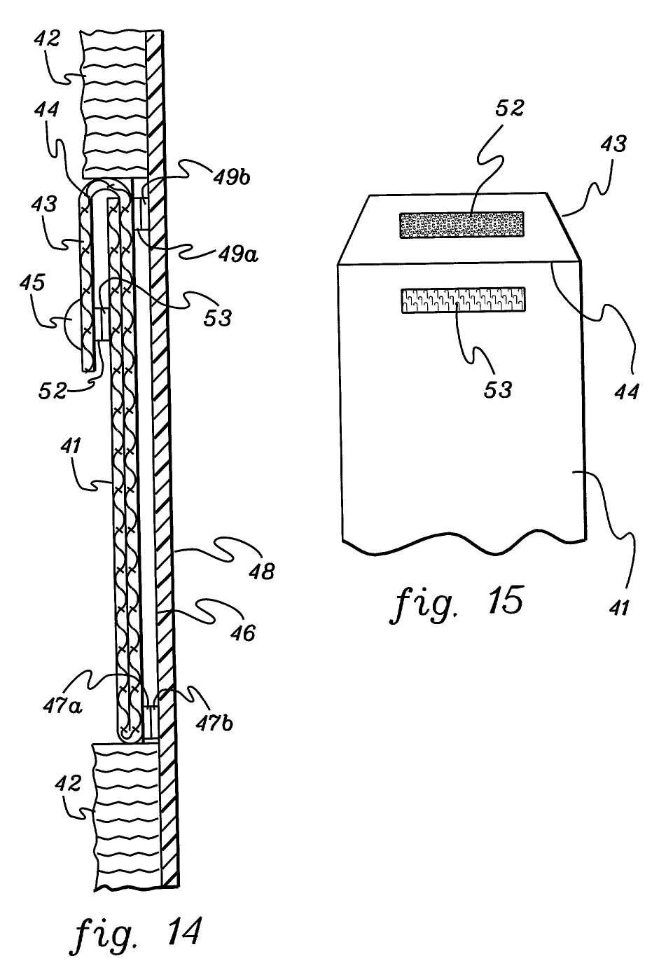

FIGS. 13-15 illustrate another aspect of the invention. FIG. 13 illustrates a partial plan view, similar to FIG. 2, of an article of manufacture 40, similar to article of manufacture 10, having one or more cavities or pockets 41 mounted on top of or in a void in a region 42 or a region 46. As in the earlier aspects of the invention, region 42 typically includes an image 44, though in one aspect of the invention no such image is present. FIG. 14 illustrates a cross sectional view of pocket 41 viewed from the direction of arrows 14-14 of FIG. 13. The aspect of the invention shown in FIGS. 13-15 is applicable to any of the articles of manufacture shown and described with respect to FIGS. 1-12, including, tufted, woven, non-woven, and fabricated carpets. As shown in FIG. 14, region 42 and pocket 41 may be mounted to a substrate 48, as described above. In one aspect of the invention, for example, when region 42 is a woven fabric, substrate 48 is not necessary, and pocket 41 may be mounted to region 46 without a substrate 48.

In one aspect of the invention, pocket 41 is made from a textile material, though any of the materials disclosed with reference to regions 12 and 16 above may used to provide pocket 41. Pocket 41 may be fixed or removably mounted to region 42 or 46. When fixed, pocket 41 may be glued or stitched to region 42 or 46 or be mounted using any of the means of attachment described above with respect to attaching legend 16. When removably mounted, pocket 41 may be mounted to region 42 or 46 by means of velcro or lacing or by means of one or more of the mechanical fasteners discussed previously. In the aspect of the invention shown in FIG. 14, pocket 41 is attached to region 46 by means of mating velcro strips 47a, 47b, 49a, and 49b. Velcro strips 47a and 49a are mounted to the back of pocket 41 while velcro strips 47b and 49b are mounted to the front of region 46 or to substrate 48. In the aspect shown in FIGS. 13-15, pocket 41 is generally rectangular in shape, but pocket 41 may take any shape, including square or circular, among other shapes.

In the aspect of the invention shown in FIGS. 13-15, pocket 41 includes a pocket flap 43, though in one aspect of the invention no flap 43 is present. FIG. 15 is a partial plan view similar to FIG. 13 in which pocket flap 43 is shown in the open position. Pocket flap 43 is retained at one end 44 and may be retained in the closed position (see FIG. 14) by any conventional means, such as, by velcro strips 52, 53 (see FIG. 15) or by means of a button and a button hole, or by means of one or more of the mechanical fasteners mentioned previously. Pocket flap 43 may have one or more novelties 45 attached to it, for example, a button, a charm, or a trinket. Novelty 45 may also be a snap or button for securing flap 43 in the closed position.

According to one aspect of the invention, cavity or pocket 41 may contain or conceal information, for example, information related to the article of manufacture displayed in image 44 in region 42 or on the legend 46. The information provided in pocket 41 may take any of the forms described with respect to the information on legend 16 described above. For instance, a pocket may contain a removable textile, card, or brochure bearing information, textual or otherwise, related to article 40, image 44 or legend 46. Information related to image 44 or legend 46 may also be displayed on the front or back face of pocket 41 or on the front or back of pocket flap 43.

The one or more cavities may also contain one or more articles, for example, a book, a soft sculpture, a stuffed animal, or a toy, among other articles. For example, in one aspect of the invention, the article contained in pocket 41 is a book, for example, a children's book related to image 44, for instance, the image of a character or scene (for example, a Mother Goose or a Harry Potter character or scene) that appears in region 42. The information provided on pocket 41 or legend 46 may also be related to the one or more articles contained in the one or more pockets 41.

While the invention has been particularly shown and described with reference to preferred embodiment, it will be understood by those skilled in the art that various changes in form and details may be made to the invention without departing from the spirit and scope of the invention described in the following claims.

1. A floor covering comprising:
a first region comprising a first material having an image; and
at least one second region comprising a second material having at least some information related to the image on the first region.

2. The floor covering as recited in claim 1, wherein the at least some information is textual, numerical, symbolic, or graphical.

3. The floor covering as recited in claim 1, wherein the first region includes a void and the second region is positioned in the void.

4. The floor covering as recited in claim 1, wherein the first region is mounted on a backing.

5. The floor covering as recited in claim 4, wherein the second region is mounted on the backing.

6. The floor covering as recited in claim 5, wherein the second region is mounted on the backing by means of an adhesive or stitching.

7. The floor covering as recited in claim 2, wherein the at least some information is textual.

8. The floor covering as recited in claim 1, wherein the first region and the second region are mounted on a common backing.

9. The floor covering as recited in claim 1, wherein the floor covering is one of a carpet, area carpet, broadloom carpet, rug, area rug, and mat.

10. A method of fabricating a floor covering, comprising:
providing a first region comprising a first material having an image; and
providing at least one second region comprising a second material having at least some information related to the image on the first region.

11. The method as recited in claim 10, wherein the first material is provided in the form of fibers.

12. The method as recited in claim 10, wherein providing at least one second region is practiced by creating a void in the first region and mounting the second region in the void.

13. The method as recited in claim 11, wherein the first region is provided by tufting fibers to a substrate.

14. The method as recited in claim 11, wherein the second material is one of a textile and non-textile material.

15. A method of fabricating a floor covering, comprising:
providing a substrate;
attaching a first material to the substrate to produce a region of first material;
providing an image on the region of first material;
providing at least one void in the region having little or no material;
providing a second material having at least some information related to the image; and
mounting the at least one second material in the at least one void.

16. The method of claim 15 wherein the first material is in the form of fibers.

17. The method as recited in claim 15 wherein the second material is one of a textile and an non-textile material.

18. The method as recited in claim 15 wherein providing a void in the region is practiced by removing material from the substrate.

19. The method as recited in claim 18, wherein removing fibers is practiced by cutting or shaving.

20. A tufted carpet comprising:
a substrate onto which fibers are tufted;
a first region of tufted fibers mounted to the substrate, the first region having an image;
a second region having little or no tufted fibers; and
a textile material providing at least some information related to the image mounted in the second region.

21. The tufted carpet as recited in claim 20, wherein the textile material is a woven or non-woven material.

22. The tufted carpet as recited in claim 20, wherein the at least some information related to the image is textual, numerical, symbolic, or graphical information.

23. The tufted carpet as recited in claim 20, wherein the at least some information related to the image is textual information.

24. The tufted carpet as recited in claim 20, wherein the at least some information provided by the textile material is provided by needlework.

25. The tufted carpet as recited in claim 24, wherein the needlework is embroidery or cross-stitch.

26. An article of manufacture comprising:
a first region comprising a first material having an image; and
at least one second region comprising a second material providing at least some information relating to the image on the first region.

27. The article of manufacture as recited in claim 26, wherein the at least some information is textual, numerical, symbolic, or graphical.

28. The article of manufacture as recited in claim 26, wherein the article is one of a floor covering; a wall hanging; a wall covering; a furniture covering; bedding; apparel; a table cloth; a napkin; a towel; and wash cloth.

29. The article of manufacture as recited in claim 26, wherein the first material is one of a tufted material, a woven material, and a non-woven material.

30. The article of manufacture as recited in claim 26, wherein the second textile material is one of a woven material and non-woven material.

31. The article of manufacture as recited in claim 27, wherein the information is provided as needlework.

32. The article of manufacture as recited in claim 31, wherein the needlework is one of embroidery, cross-stitch, and crocheting.

33. The article of manufacture as recited in claim 26, wherein the image is an image of one of geometrical designs, graphic designs, photographs, images of articles, images of fashions, plants, animals, people, events, landscapes, landmarks, scenes of nature, concepts, ideas, scientific concepts and principles, literary works, works of art, historic scenes, signs of the zodiac, brands, trademarks, trade dress, insignias, tartans, genealogical symbols, images of heraldry, and coats of arms.

34. The article of manufacture as recited in claim 26, wherein the first region includes a perimeter and the at least one second region is positioned within the perimeter.

35. The article of manufacture as recited in claim 26, wherein the at least one second region is a plurality of second regions.

36. The article of manufacture as recited in claim 26, wherein the second material is different from the first material.

37. A method of providing an article of manufacture, the method comprising:
providing a first region of the article having an image; and
providing a second region of the article containing at least some information concerning the image.

38. The method as recited in claim 37, wherein the at least some information is textual, numerical, symbolic, or graphical.

39. The method as recited in claim 37, wherein the article is one of a floor covering; a wall hanging; a wall covering; a furniture covering; bedding; apparel; a table cloth; a napkin; a towel; and wash cloth.

40. The method as recited in claim 38, wherein the at least some information is textual.

41. The method as recited in claim 37, further comprising providing a substrate for mounting the first region.

42. The method as recited in claim 41, wherein providing a first region of the article is practiced by tufting fibers to the substrate.

43. The method as recited in claim 37, wherein the second region is provided by removing at least some of the first region to produce a void in the first region and mounting a textile having at least some information related to the image in the void.

44. The method as recited in claim 43, further comprising providing the at least some information to the textile material by means of needlework.

45. An article of manufacture comprising:
a first region comprising a first material having an image, the first region having a perimeter and at least one void within the perimeter; and
at least one second region positioned within the void comprising a second material containing at least some information related to the image.

46. The article as recited in claim 45, wherein the at least some information is textual, numerical, symbolic, or graphical.

47. The article as recited in claim 46, wherein the at least some information is textual.

48. The article as recited in claim 45, wherein at least one second region is a plurality of second regions.

49. The article as recited in claim 46, wherein the first material is a woven or non-woven material.

50. The article as recited in claim 46, further comprising a backing.

51. The floor covering as recited in claim 1, wherein the image and the at least some information are provided on the same side of the floor covering.

52. The tufted carpet as recited in claim 20, wherein the image and the at least some information are provided on the same side of the tufted carpet.

53. The article of manufacture as recited in claim 26, wherein the image and the at least some information are provided on the same side of the article.

54. The floor covering as recited in claim 1, further comprising a pocket.

55. The tufted carpet as recited in claim 20, further comprising a pocket.

56. The article of manufacture as recited in claim 26, further comprising a pocket.
